(19) United States
(12) Patent Application Publication
(10) Pub. No.: US 2024/0041192 A1
(43) Pub. Date: Feb. 8, 2024

(54) One-piece phone case grip holder

(71) Applicant: Fangmin Jiang, Wugang (CN)

(72) Inventor: Fangmin Jiang, Wugang (CN)

(21) Appl. No.: 18/242,553

(22) Filed: Sep. 6, 2023

(30) Foreign Application Priority Data
Jul. 18, 2023 (CN) 202321898024.4

(51) Int. Cl. A45F 5/00

(52) U.S. Cl. CPC A45F 5/00; A45F 2200/0516; A45F 2005/008

(57) ABSTRACT

A one-piece phone case grip holder includes a case body, a slot formed on the inner surface of the case body, a through hole formed in one end of the slot, a flexible finger ring strap arranged in the through hole, one end of the flexible finger ring strap being secured to the case body and the other end thereof being slidably connected to the slots, and a cover plate disposed on the flexible finger ring strap. Two slots are provided in another embodiment.

### BACKGROUND OF THE INVENTION

### 1. Field of the Invention

The invention relates to phone cases and more particularly to a one-piece phone case grip holder.

### 2. Description of Related Art

A case body is an ornament to protect or decorate the appearance of a mobile phone. With the rapid development of technology, the technology beauty industry has emerged as a new industry. Vogue IT brands witness further development with the diversification of the market. Protective case bodies are diversified due to the increase of phone brands and functions, and are divided into PC cases, leather cases, silica gel cases, fabric cases, hard plastic cases, genuine leather cases, metallic tempered glass cases, soft plastic cases, velvet cases, silk cases, and the like. The protective case bodies not only are ornaments to make mobile phones become a new view, but also protect the mobile phones from being broken due to falling and being scratched, and achieve waterproof and shockproof as well.

However, in actual use, case bodies on the market are increasingly exquisite and beautiful, but their functions are relatively single, being capable of only providing simple protection of mobile phones, most of these case bodies can be used in combination with finger ring kickstands when users hold the phones with one hand, and the finger ring kickstands are bonded to the back of the mobile phones, making a bulge structure formed thereon, which reduces the overall sense of use.

Thus, the need for improvement still exists.

### SUMMARY OF THE INVENTION

In order to overcome the above defects in the prior art, the invention provides a one-piece phone case grip holder to solve the problems mentioned in the background art.

In order to achieve the above objective, the invention provides a one piece phone case grip holder, comprising a case body; at least one set of slots formed on the inner surface of the case body; a through hole formed on one side of each slot; a flexible finger ring strap with a certain resilience arranged inside the through hole wherein one end of the flexible finger ring strap is fixedly connected to the case body and the other end of the flexible finger ring strap is slidably connected to the slots; and a cover plate embedded above the flexible finger ring strap.

Preferably, a width of the through hole is less than a width of the slot.

Preferably, a width of the flexible finger ring strap is equal to or less than the width of the through hole.

Preferably, further comprises a limiting plinth disposed on a first end of an outer surface of the flexible finger ring strap wherein a width of the limiting plinth is less than or equal to the width of the slot, and the width of the limiting plinth is greater than the width of the through hole.

Preferably, thicknesses of the limiting plinth and the flexible finger ring strap are equal to or less than a height of the slot.

Preferably, further comprises at least one boss disposed on the outer surface of the flexible finger ring strap.

Preferably, further comprises a camera opening disposed at a corner of the case body, and a plurality of button body bodies disposed on a side of the case body.

Preferably, the slot is disposed in an outer surface of the case body.

The invention has the beneficial technical effects and advantages:

The invention improves the previous design of the case bodies, the case body and the flexible finger ring strap are made in one piece, and there is no bulge on the case body on the whole, improving the overall aesthetics of the case body. When the flexible finger ring strap is pulled out of from the through hole, the forefinger and middle finger of the user can be plugged into the flexible finger ring strap, such that the mobile phone can be held with one hand, facilitating the operation of the user, and guaranteeing relative stability of the mobile phone and the hand. When not being used, the flexible finger ring strap can be hidden in the through hole, improving the overall portability.

The above and other objects, features and advantages of the invention will become apparent from the following detailed description taken with the accompanying drawings.

### BRIEF DESCRIPTION OF THE DRAWINGS

FIG. 1 is a perspective view of a case body according to a first preferred embodiment of the invention, a flexible finger ring strap being pulled to shape as an arc in a use position;

FIG. 2 is another perspective view of the case body;

FIG. 3 is a view similar to FIG. 2 with the cover plate detached;

FIG. 4 is a perspective view of the flexible finger ring strap;

FIG. 5 is a view similar to FIG. 1, the flexible finger ring strap being pressed to be flat in a non-use position; and

FIG. 6 is a perspective view of a case body according to a second preferred embodiment of the invention.

### DETAILED DESCRIPTION OF THE INVENTION

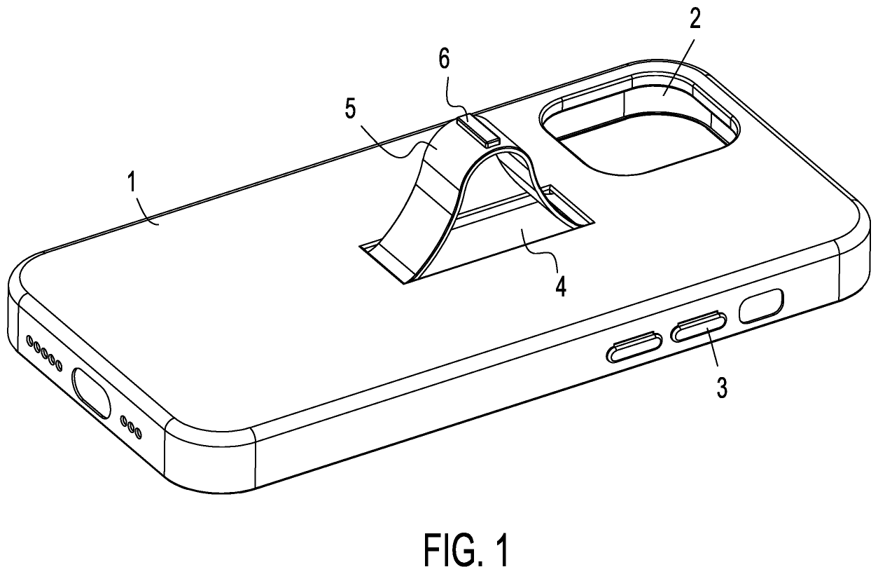

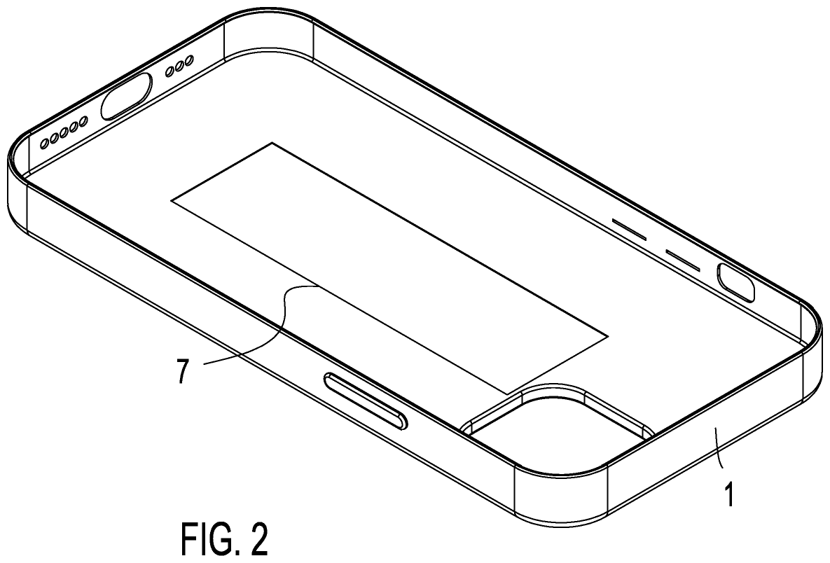

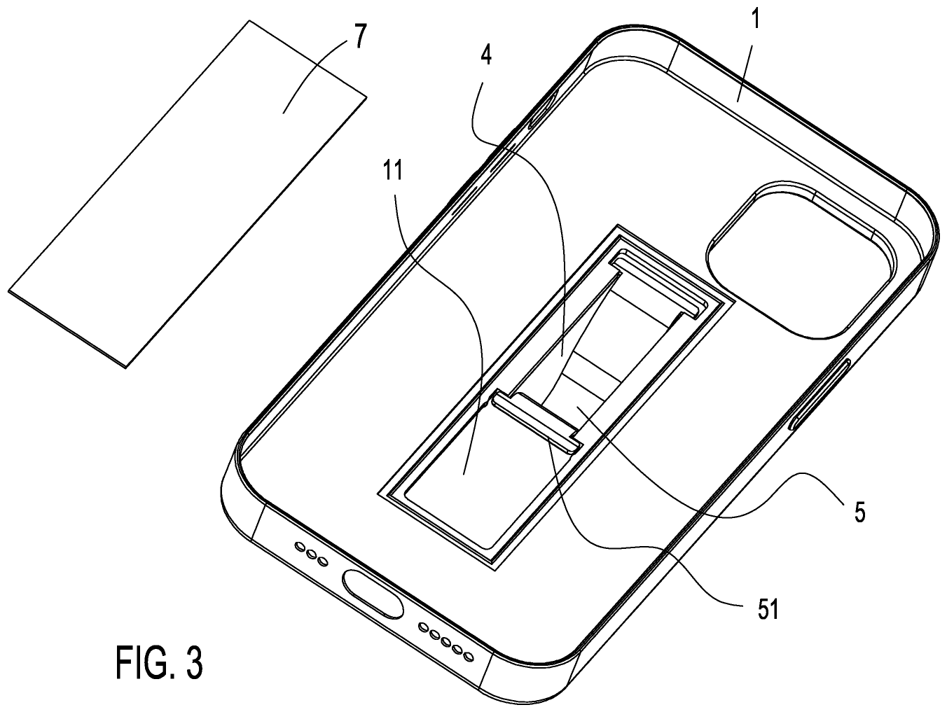

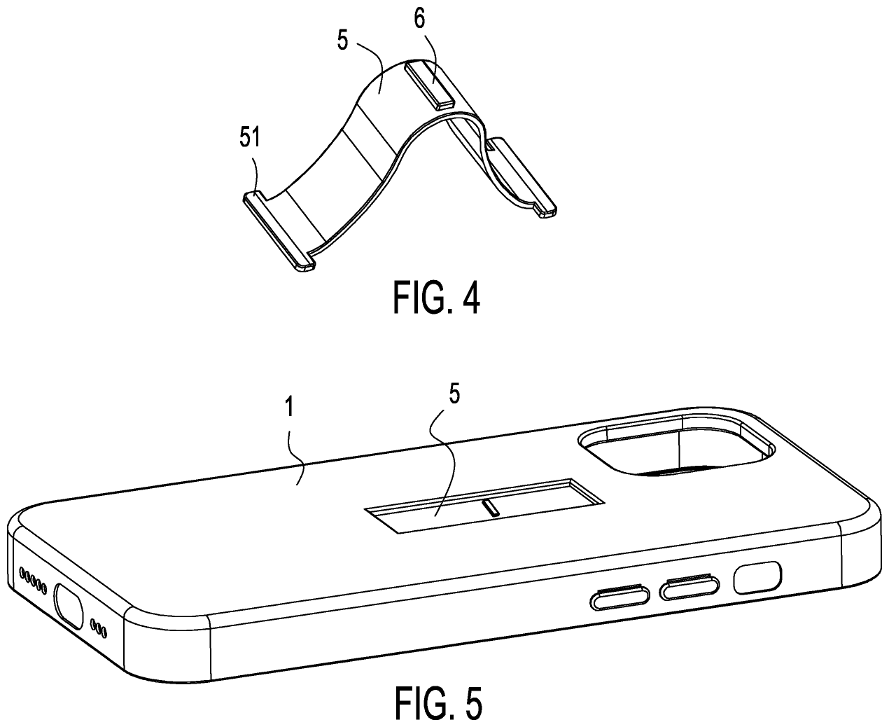

Referring to FIGS. 1 to 5, a case body 1 of a mobile phone in accordance with a first preferred embodiment of the invention is shown and comprises a slot 11 disposed in an inner surface, a through hole 4 disposed in one end of the slot 11, a flexible finger ring strap 5 with a certain resilience arranged in the through hole 14, one end of the flexible finger ring strap 5 being fixedly connected to the case body 1, the other end of the flexible finger ring strap 5 being slidably connected to the slot 11, and a cover plate 7 disposed on both the slot 11 and the through hole 4. In a specific implementation, the cover plate 7 is fixed on the case body 1 by glue, or by means of snap fastening or by screws, so as to prevent the flexible finger ring strap 5 from falling off. The flexible finger ring strap 5 is made of one of fabric, plastic, leather, and silica gel with a certain resilience.

A width of the through hole 4 is less than a width of the slot 11. A width of the flexible finger ring strap 5 is equal to or less than the width of the through hole 4 so that the flexible finger ring strap 5 can pass through the through hole 4 and can be accommodated in the slot 11.

A limiting plinth 51 is arranged on one end of an outer surface of the flexible finger ring strap 5. A width of the limiting plinth 51 is less than or equal to the width of the width of the slot 11. The width of the limiting plinth 51 is greater than the width of the through hole 4 so as to facilitate the sliding of the flexible finger ring strap 5. Thicknesses of the limiting plinth 51 and the flexible finger ring strap 5 are equal to or less than a height of the slot 11 so as to improve the overall aesthetics of the product. The arrangement of the limiting plinth 51 can prevent the flexible finger ring strap 5 from disengaging from the slot 11. In a specific implementation, the other end of the flexible finger ring strap 5 is disposed in one end of the through hole 4 and fixedly connected to the case body 1. The limiting plinth 51 is slidably connected to the slot 11. A boss 6 is arranged on the upper surface of the flexible finger ring strap 5. The boss 6 can be pressed to flatten the flexible finger ring strap 5 for storage or pulled to bend the flexible finger ring strap 5 in a use position. A camera opening 2 is disposed at a corner of the case body 1. A plurality of button body bodies are provided on one side of the case body 1. Alternatively, the camera opening 2 can be arranged at an arbitrary position on the surface of the case body 1, such that it can be adapted to mobile phones of different brands and models.

Further, the slot 11 can also be arranged on an outer surface of the case body 1 so as to effectively increases different mounting scenarios of the flexible finger ring strap 5 and facilitate the selection of a more convenient assembly method.

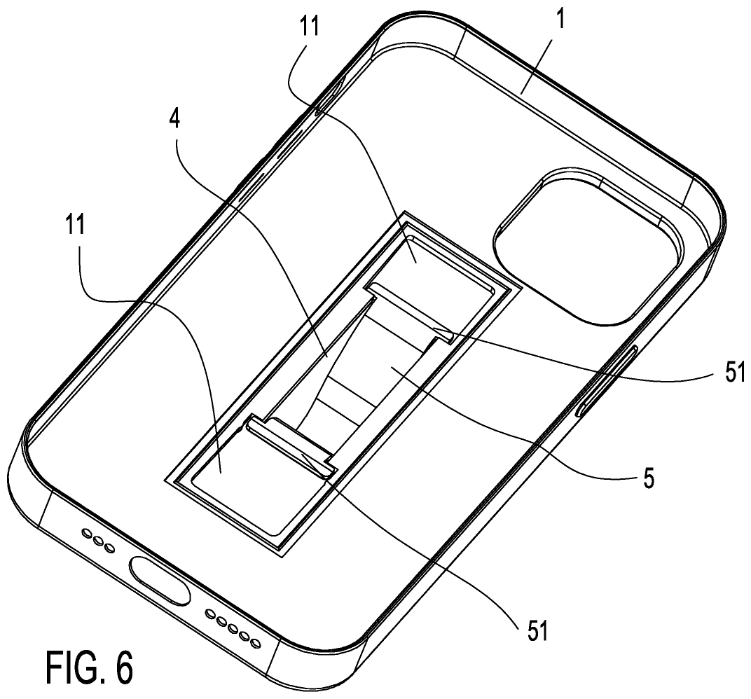

Referring to FIG. 6, a case body 1 of a mobile phone in accordance with a second preferred embodiment of the invention is shown. The characteristics of the second preferred embodiment are substantially the same as that of the first preferred embodiment except the following:

Two slots 11 are provided. The through hole 4 is arranged between the slots 11. Two limiting plinths 51 are arranged at two ends of the flexible finger ring strap 5 respectively. The limiting plinth 51 at one end of the flexible finger ring strap 5 is slidably connected to one slot 11 adjacent to the front end and the other limiting plinth 51 at the other end of the flexible finger ring strap 5 is slidably connected to the other slot 11 adjacent to the rear end. When the flexible finger ring strap 5 is pressed, the flexible finger ring strap 5 slides in the slots 11 to flatten in the slots 11. When the flexible finger ring strap 5 is pulled, two ends of the flexible finger ring strap 5 slide in the slots 11 to become an arc in a ready to use position.

Components and operations of the invention are briefed below. The invention provides a one-piece phone case grip holder. The case body 1 is made of PVC material or plastic by means of injection molding. The camera opening 2 and the button body bodies 3 correspond to the model of a mobile phone. One end of the flexible finger ring strap 5 is fixedly connected to the case body 1 at one end of the through hole 4 and the other end of the flexible finger ring strap 5 is slidably connected to the slot 11. The cover plate 7 is disposed on the slot 11. The flexible finger ring strap 5 and the through hole 4 form a whole. When being used as a whole, the case body 1 is disposed on a mobile phone, the boss 6 can be pulled to shape an arched finger ring hole formed by the flexible finger ring strap 5 from the through hole 4, any finger of a user can be inserted into the arched finger ring hole, such that the mobile phone can be held by one hand, thereby facilitating the operation by the user. When not being used, the flexible finger ring strap 5 can be pressed to dispose in the through hole 4.

While the invention has been described in terms of preferred embodiments, those skilled in the art will recognize that the invention can be practiced with modifications within the spirit and scope of the appended claims.

What is claimed is:

1. A one-piece phone case grip holder, comprising a case body, wherein at least one set of slots is formed on the inner surface of the case body, a through hole is formed on one side of each slot, a flexible finger ring strap with a certain resilience is arranged inside the through hole, one end of the flexible finger ring strap is fixedly connected to the case body, the other end of the flexible finger ring strap is slidably connected to the slots, and a cover plate is embedded above the flexible finger ring strap.

2. The one-piece phone case grip holder according to claim 1, wherein the width of the through hole is less than the width of the slot.

3. The one-piece phone case grip holder according to claim 1, wherein the width of the flexible finger ring strap equals to or is less than the width of the through hole.

4. The one-piece phone case grip holder according to claim 1, wherein the limiting plinth is arranged on one end of the flexible finger ring strap that corresponds to the slots, the width of the limiting plinth is less than or equals to the width of the slot, and the width of the limiting plinth is greater than the width of the through hole.

5. The one-piece phone case grip holder according to claim 4, wherein the thicknesses of the limiting plinth and the flexible finger ring strap equal to or are less than the height of the slot.

6. The one-piece phone case grip holder according to claim 1, wherein at least one set of bosses is arranged on the upper surface of the flexible finger ring strap.

7. The one-piece phone case grip holder according to claim 1, wherein the camera slot is formed at a corner position of the case body, and a plurality of sets of button bodies are also provided on one side of the case body.

8. The one-piece phone case grip holder according to claim 1, wherein the slots can also be arranged on the surface of the case body.
